(19) United States
(12) Patent Application Publication
(10) Pub. No.: US 2024/0338418 A1
(43) Pub. Date: Oct. 10, 2024

(54) SYSTEM AND METHOD FOR ACCELERATING BENDERS DECOMPOSITION VIA REINFORCEMENT LEARNING SURROGATE MODELS

(71) Applicant: JPMorgan Chase Bank, N.A., New York, NY (US)

(72) Inventors: Kyle MANA, Renton, WA (US); Parisa ZEHTABI, London (GB); Hoa Lun Stephen MAK, Glasgow (GB); Michael CASHMORE, Stirlingshire (GB); Daniele MAGAZZENI, London (GB); Manuela VELOSO, New York, NY (US); Daniel A KIRSNER, Oak Park, IL (US); Ryan EIBEN, Lewis Center, OH (US); Donald STEPHENS, Hollis, NY (US); Lei Carol LIANG, Hamburg, NJ (US); Fernando ACERO, London (GB)

(73) Assignee: JPMorgan Chase Bank, N.A., New York, NY (US)

(21) Appl. No.: 18/371,270

(22) Filed: Sep. 21, 2023

Related U.S. Application Data
(60) Provisional application No. 63/457,269, filed on Apr. 5, 2023.

(51) Int. Cl. G06F 17/11

(52) U.S. Cl. CPC G06F 17/11

(57) ABSTRACT

Various methods, apparatuses/systems, and media for accelerating decomposition via reinforcement learning are disclosed. A processor implements a decomposition algorithm that allows a solution of a comparatively larger linear programming problems that have a special block structure; inserts a reinforcement learning agent within a framework of the decomposition algorithm; and generates, in response to inserting the reinforcement learning agent, master problem decisions in place of an NP-hard (nondeterministic polynomial time-hard) mixed-integer master problem (MIMP).

### CROSS-REFERENCE TO RELATED APPLICATIONS

This application claims the benefit of priority from U.S. Provisional Patent Application No. 63/457,269, filed Apr. 5, 2023, which is herein incorporated by reference in its entirety.

### TECHNICAL FIELD

This disclosure generally relates to data processing, and, more particularly, to methods and apparatuses for implementing a language and platform agnostic accelerated Benders decomposition module for accelerating decomposition via reinforcement learning.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Benders decomposition (BD) may refer to a technique in mathematical programming that may allow the solution of very large linear or mixed integer programming problems that have a special block structure. This block structure often occurs in applications such as stochastic programming as the uncertainty is usually represented with scenarios. Stochastic optimization (SO) may attempt to offer optimal decisions in the presence of uncertainty. Often, the classical formulation of these problems becomes intractable due to a) the number of scenarios required to capture the uncertainty and b) the discrete nature of real-world planning problems.

Moreover, optimization may frequently be subjected to conditions of uncertainty. If this uncertainty is not sufficiently accounted for by a solution, even minor perturbations in the environment may devalue results and lead to catastrophic outcomes. While uncertainty may often be simulated or even parameterized, solving over that uncertainty may still offer incredible complexity. To make optimal decisions that consider both the uncertainty and constraints of a system, the field of SO is often applied. SO considers a distribution of possible scenarios rather than a deterministic event, and seeks to optimize the outcome across the range of possibilities.

A common challenge, however, for SO is tractability. Generating an optimal decision that considers its outcome across a large number of scenarios can be extremely costly. To combat these computational issues, a conventional approach is to decompose the problem into simpler and independent sub-problems that can be combined to retrieve a global certificate of optimality.

Despite wide usage since its introduction, BD suffers from two well-known practical limitations. First, in discrete space BD relies on an NP-hard (Nondeterministic Polynomial time-hard) Mixed-Integer Master Problem (MIMP). This MIMP is responsible for making global decisions that are homogeneous across scenarios. Second, with each iteration a set of scenario-specific sub-problems (SP) generate gradient approximations that are passed to the MIMP as constraints. The result is an MIMP with complexity that scales linearly with the number of required iterations as constraints are added.

Given these deficiencies, accelerating BD has become a compelling research problem. Some conventional attempts have been made to address these issues, but failed to provide optimal results. For example, in production routing applications, one approach was proposed where lower-bound lifting inequalities are implemented to tighten initial lower bounds, and scenario grouping is exploited to reduce added complexity at each iteration. Another approach attempted to localize the loss approximation of BD by restricting each iteration to a subspace centered around strong past solutions. Yet, other tried to aid initial iterations by including an informative subset of scenarios within the MIMP. A machine learning approach was also offered to predicting constraint importance; retaining only important cuts and limiting MIMP complexity. Each of these proposals has shown computational benefits, but remain solely dependent on the expensive MIMP to generate successive solutions. In contrast, another approach was proposed in which the MIMP is replaced with a genetic algorithm to produce faster feasible solutions. Although the heuristic produces fast master problem (MP) solutions, it is still reliant on SP approximations to understand scenario loss, and offers feasible as opposed to certifiably optimal solutions.

Thus, there is a need for an advanced method and tools that can address these conventional shortcomings corresponding to BD.

### SUMMARY

The present disclosure, through one or more of its various aspects, embodiments, and/or specific features or sub-components, provides, among other features, various systems, servers, devices, methods, media, programs, and platforms for implementing a language and platform agnostic accelerated BD module for accelerating decomposition via reinforcement learning, but the disclosure is not limited thereto.

For example, the present disclosure, through one or more of its various aspects, embodiments, and/or specific features or sub-components, provides, among other features, various systems, servers, devices, methods, media, programs, and platforms for implementing a language and platform agnostic accelerated BD module for introducing a reinforcement learning (RL) agent to quickly solve the discrete MP rather than relying on the MIMP. This RL agent, according to exemplary embodiments, generates fast solutions to unseen problems after learning the loss of decisions in similar stochastic environments. At varying rates, the MIMP is still run to retrieve the certificate of optimality offered by BD. While, according to exemplary embodiments, an RL agent is utilized, any predictive model capable of mapping an environment state into a decision space can be used, and may be obtained by alternative learning-based approaches such as imitation learning, meta-heuristic approaches, or other approaches that can learn from experience. It should be noted that the RL agent may also be referred to as an MP-agent without departing from the scope of the present disclosure.

According to exemplary embodiments, a method is disclosed for accelerating BD that retrieves optimal solutions to stochastic optimization problems while drastically reducing run times.

According to exemplary embodiments, a solution selection method is disclosed that uses cuts from BD sub-problems to inform selection of future MP-agent solutions; offering a further unification of the MP-agent within the BD framework.

According to exemplary embodiments, a worked inventory management problem with detailed implementation of the acceleration method is also disclosed herein.

According to exemplary embodiments, the accelerated BD module implements an explicit Benders formulation, RL state-space description, and example unification.

For example, according to exemplary embodiments, a method for accelerating decomposition via reinforcement learning by utilizing one or more processors along with allocated memory is disclosed. The method may include: implementing, by at least one processor, a decomposition algorithm that allows a solution of a comparatively larger linear programming problems that have a special block structure; inserting, by said at least one processor, a reinforcement learning agent within a framework of the decomposition algorithm; and generating, by said at least one processor, in response to inserting the reinforcement learning agent, master problem decisions in place of an NP-hard MIMP, thereby resulting about 30% reduction in run-time versus alternative acceleration methods.

According to exemplary embodiments, the block structure may occur in applications that include stochastic programming as uncertainty is represented with scenarios.

According to exemplary embodiments, the decomposition algorithm is BD algorithm that decomposes stochastic optimization problems on the basis of scenario independence into BD sub-problems.

According to exemplary embodiments, the method may further include: implementing cuts from the BD sub-problems; notifying, in response to implementing the cuts, selection of future master problem (MP)-agent solutions; and combining the MP-agent solutions within a BD framework.

According to exemplary embodiments, the reinforcement learning agent may be configured to generate solutions to unseen problems after learning a loss of decisions in similar stochastic environments.

According to exemplary embodiments, the method may further include: updating behaviors of the reinforcement learning agent based on learning the loss of decisions in similar stochastic environments.

According to exemplary embodiments, for each iteration, a decision to use the reinforcement learning agent in place of the MIMP is drawn from a Bernoulli distribution with a control parameter, and when a value of “1” is returned from the Bernoulli distribution, the reinforcement learning agent is used to generate global decisions, and when a value of “0” is returned from the Bernoulli distribution, the MIMP is run and an optimality gap is confirmed, but the disclosure is not limited thereto. For example, the use of a Bernoulli distribution can be replaced by any other selection heuristic that switches between the RL agent and the MIMP without departing from the scope of the present disclosure.

According to exemplary embodiments, a system for accelerating decomposition via reinforcement learning is disclosed. The system may include: a processor; and a memory operatively connected to the processor via a communication interface, the memory storing computer readable instructions, when executed, may cause the processor to: implement a decomposition algorithm that allows a solution of a comparatively larger linear programming problems that have a special block structure; insert a reinforcement learning agent within a framework of the decomposition algorithm; and generate, in response to inserting the reinforcement learning agent, master problem decisions in place of an NP-hard MIMP.

According to exemplary embodiments, the processor may be further configured to: implement cuts from the BD sub-problems; notify, in response to implementing the cuts, selection of future MP-agent solutions; and combine the MP-agent solutions within a BD framework.

According to exemplary embodiments, the processor may be further configured to: update behaviors of the reinforcement learning agent based on learning the loss of decisions in similar stochastic environments, wherein for each iteration, a decision to use the reinforcement learning agent in place of the MIMP is drawn from a Bernoulli distribution with a control parameter, and when a value of “1” is returned from the Bernoulli distribution, the reinforcement learning agent is used to generate global decisions, and when a value of “0” is returned from the Bernoulli distribution, the MIMP is run and an optimality gap is confirmed, but the disclosure is not limited thereto. For example, the use of a Bernoulli distribution can be replaced by any other selection heuristic that switches between the RL agent and the MIMP without departing from the scope of the present disclosure.

According to exemplary embodiments, a non-transitory computer readable medium configured to store instructions for accelerating decomposition via reinforcement learning is disclosed. The instructions, when executed may cause a processor to perform the following: implementing a decomposition algorithm that allows a solution of a comparatively larger linear programming problems that have a special block structure; inserting a reinforcement learning agent within a framework of the decomposition algorithm; and generating, in response to inserting the reinforcement learning agent, master problem decisions in place of an NP-hard MIMP.

According to exemplary embodiments, the instructions, when executed, may cause the processor to further perform the following: implementing cuts from the BD sub-problems; notifying, in response to implementing the cuts, selection of future MP-agent solutions; and combining the MP-agent solutions within a BD framework.

According to exemplary embodiments, the instructions, when executed, may cause the processor to further perform the following: updating behaviors of the reinforcement learning agent based on learning the loss of decisions in similar stochastic environments, wherein for each iteration, a decision to use the reinforcement learning agent in place of the MIMP is drawn from a Bernoulli distribution with a control parameter, and when a value of “1” is returned from the Bernoulli distribution, the reinforcement learning agent is used to generate global decisions, and when a value of “0” is returned from the Bernoulli distribution, the MIMP is run and an optimality gap is confirmed, but the disclosure is not limited thereto. For example, the use of a Bernoulli distribution can be replaced by any other selection heuristic that switches between the RL agent and the MIMP without departing from the scope of the present disclosure.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform and language accelerated BD module for accelerating decomposition via RL in accordance with an exemplary embodiment.

FIG. 2 illustrates an exemplary diagram of a network environment with a platform and language agnostic accelerated BD device in accordance with an exemplary embodiment.

FIG. 3 illustrates a system diagram for implementing a platform and language agnostic accelerated BD device having a platform and language agnostic accelerated BD module in accordance with an exemplary embodiment.

FIG. 4 illustrates a system diagram for implementing a platform and language agnostic accelerated BD module of FIG. 3 in accordance with an exemplary embodiment.

FIG. 5 illustrates an exemplary iterative procedure of Benders decomposition, alternating between MIMP and SP as implemented by the platform and language agnostic accelerated BD module of FIG. 4 in accordance with an exemplary embodiment.

FIG. 6 illustrates an exemplary iterative procedure of RL-Master as implemented by the platform and language agnostic accelerated BD module of FIG. 4 in accordance with an exemplary embodiment.

FIG. 7 illustrates an exemplary chart showing convergence instances of BD with and without RL-Master as implemented by the platform and language agnostic accelerated BD module of FIG. 4 in accordance with an exemplary embodiment.

FIG. 8 illustrates an exemplary chart showing convergence rates of BD with and without RL-Master iterative procedure of RL-Master as implemented by the platform and language agnostic accelerated BD module of FIG. 4 in accordance with an exemplary embodiment.

FIG. 9 illustrates an exemplary chart showing convergence rates of BD accelerated by an informed MP-agent, with different RL usages as implemented by the platform and language agnostic accelerated BD module of FIG. 4 in accordance with an exemplary embodiment.

FIG. 10 illustrates an exemplary chart showing convergence instances of BD accelerated by an informed MP-agent, with different RL usages as implemented by the platform and language agnostic accelerated BD module of FIG. 4 in accordance with an exemplary embodiment.

FIG. 11 illustrates an exemplary flow chart of a process implemented by the platform and language agnostic accelerated BD module of FIG. 4 for accelerating decomposition via reinforcement learning in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

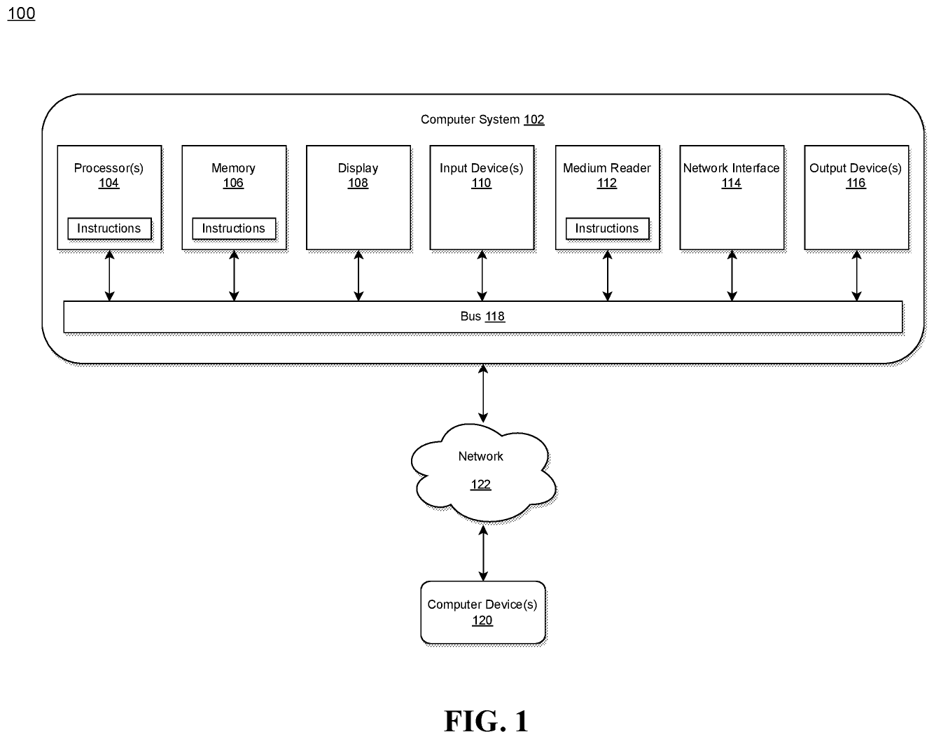

FIG. 1 is an exemplary system 100 for use in implementing a platform and language agnostic accelerated BD module that may be configured for automatically accelerating decomposition via RL in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the accelerated Benders decomposition module may be platform and language agnostic that may allow for consistent easy orchestration and passing of data through various components to output a desired result. Since the disclosed process, according to exemplary embodiments, is platform and language agnostic, the accelerated Benders decomposition module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

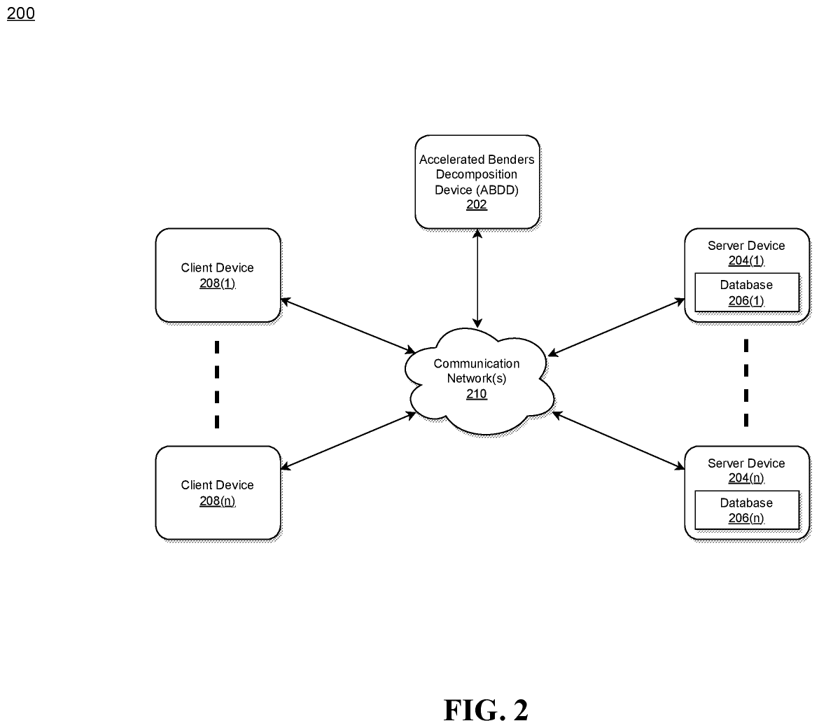

Referring to FIG. 2, a schematic of an exemplary network environment 200 for implementing a platform and language accelerated Benders decomposition device (ABDD) of the instant disclosure is illustrated.

According to exemplary embodiments, the above-described problems associated with conventional tools may be overcome by implementing an ABDD 202 as illustrated in FIG. 2 that may be configured for implementing a platform and language agnostic accelerated Benders decomposition module for accelerating decomposition via reinforcement learning, but the disclosure is not limited thereto.

The ABDD 202 may be the same or similar to the computer system 102 as described with respect to FIG. 1.

The ABDD 202 may store one or more applications that can include executable instructions that, when executed by the ABDD 202, cause the ABDD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ABDD 202 itself, may be located in virtual server(s) running in a cloud-based computing environment rather than being tied to one or more specific physical network computing devices. Also, the application(s) may be running in one or more virtual machines (VMs) executing on the ABDD 202. Additionally, in one or more embodiments of this technology, virtual machine(s) running on the ABDD 202 may be managed or supervised by a hypervisor.

In the network environment 200 of FIG. 2, the ABDD 202 is coupled to a plurality of server devices 204(1)-204(n) that hosts a plurality of databases 206(1)-206(n), and also to a plurality of client devices 208(1)-208(n) via communication network(s) 210. A communication interface of the ABDD 202, such as the network interface 114 of the computer system 102 of FIG. 1, operatively couples and communicates between the ABDD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ABDD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ABDD 202 may be a standalone device or integrated with one or more other devices or apparatuses, such as one or more of the server devices 204(1)-204(n), for example. In one particular example, the ABDD 202 may be hosted by one of the server devices 204(1)-204(n), and other arrangements are also possible. Moreover, one or more of the devices of the ABDD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ABDD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the ABDD 202 that may efficiently provide a platform for implementing a platform and language agnostic accelerated Benders decomposition module for accelerating decomposition via reinforcement learning as disclosed herein, but the disclosure is not limited thereto.

The client devices 208(1)-208(n) may run interface applications, such as standard web browsers or standalone client applications, which may provide an interface to communicate with the ABDD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the ABDD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ABDD 202, the server devices 204(1)-204(n), or the client devices 208(1)-208(n), for example, may be configured to operate as virtual instances on the same physical machine. For example, one or more of the ABDD 202, the server devices 204(1)-204(n), or the client devices 208(1)-208(n) may operate on the same physical device rather than as separate devices communicating through communication network(s) 210. Additionally, there may be more or fewer ABDDs 202, server devices 204(1)-204(n), or client devices 208(1)-208(n) than illustrated in FIG. 2. According to exemplary embodiments, the ABDD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

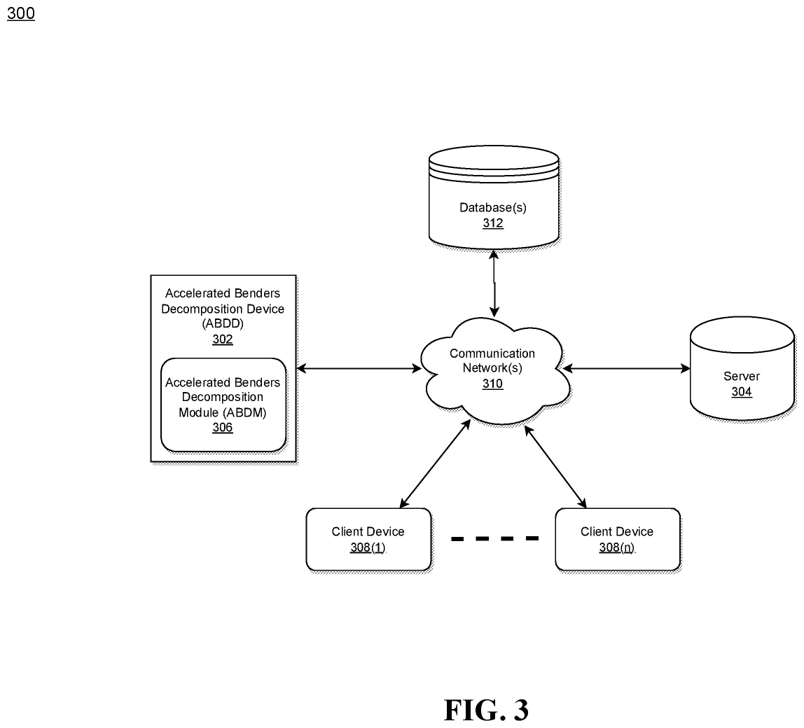

FIG. 3 illustrates a system diagram for implementing an ABDD having a platform and language agnostic accelerated BD module (ABDM) in accordance with an exemplary embodiment.

As illustrated in FIG. 3, the system 300 may include an ABDD 302 within which an ABDM 306 is embedded, a server 304, a database(s) 312, a plurality of client devices 308(1) . . . 308(n), and a communication network 310.

According to exemplary embodiments, the ABDD 302 including the ABDM 306 may be connected to the server 304, and the database(s) 312 via the communication network 310. The ABDD 302 may also be connected to the plurality of client devices 308(1) . . . 308(n) via the communication network 310, but the disclosure is not limited thereto.

According to exemplary embodiment, the ABDD 302 is described and shown in FIG. 3 as including the ABDM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) may be a mainframe database, a log database that may produce programming for searching, monitoring, and analyzing machine-generated data via a web interface, etc., but the disclosure is not limited thereto.

According to exemplary embodiments, the ABDM 306 may be configured to receive real-time feed of data from the plurality of client devices 308(1) . . . 308(n) via the communication network 310.

As will be described below, the ABDM 306 may be configured to: implement a decomposition algorithm that allows a solution of a comparatively larger linear programming problems that have a special block structure; insert a reinforcement learning agent within a framework of the decomposition algorithm; and generate, in response to inserting the reinforcement learning agent, master problem decisions in place of an NP-hard MIMP, but the disclosure is not limited thereto.

The plurality of client devices 308(1) . . . 308(n) are illustrated as being in communication with the ABDD 302. In this regard, the plurality of client devices 308(1) . . . 308(n) may be “clients” (e.g., customers) of the ABDD 302 and are described herein as such. Nevertheless, it is to be known and understood that the plurality of client devices 308(1) . . . 308(n) need not necessarily be “clients” of the ABDD 302, or any entity described in association therewith herein. Any additional or alternative relationship may exist between either or both of the plurality of client devices 308(1) . . . 308(n) and the ABDD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the ABDD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ABDD 302 may be the same or similar to the ABDD 202 as described with respect to FIG. 2, including any features or combination of features described with respect thereto.

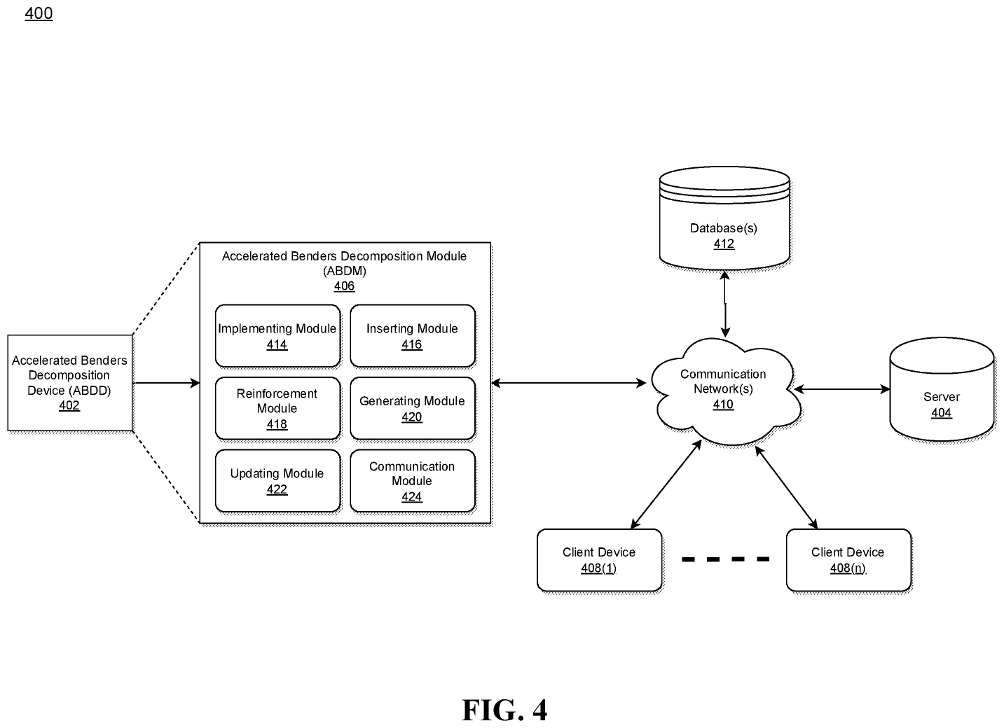

FIG. 4 illustrates a system diagram for implementing an ABDM of FIG. 3 in accordance with an exemplary embodiment.

According to exemplary embodiments, the system 400 may include a platform and language agnostic ABDD 402 within which a platform and language agnostic ABDM 406 is embedded, an application 403, a server 404, database(s) 412, and a communication network 410.

According to exemplary embodiments, the ABDD 402 including the ABDM 406 may be connected to the application 403, the server 404, and the database(s) 412 via the communication network 410. The ABDD 402 may also be connected to the plurality of client devices 408(1)-408(n) via the communication network 410, but the disclosure is not limited thereto. The ABDM 406, the server 404, the plurality of client devices 408(1)-408(n), the database(s) 412, the communication network 410 as illustrated in FIG. 4 may be the same or similar to the ABDM 306, the server 304, the plurality of client devices 308(1)-308(n), the database(s) 312, the communication network 310, respectively, as illustrated in FIG. 3.

According to exemplary embodiments, as illustrated in FIG. 4, the ABDM 406 may include an implementing module 414, an inserting module 416, a reinforcement module 418, a generating module 420, an updating module 422, and a communication module 424. According to exemplary embodiments, interactions and data exchange among these modules included in the ABDM 406 provide the advantageous effects of the disclosed invention. Functionalities of each module of FIG. 4 will be described in detail below.

According to exemplary embodiments, each of the implementing module 414, inserting module 416, reinforcement module 418, generating module 420, updating module 422, and the communication module 424 of the ABDM 406 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the implementing module 414, inserting module 416, reinforcement module 418, generating module 420, updating module 422, and the communication module 424 of the ABDM 406 may be implemented by microprocessors or similar, and may be programmed using software (e.g., microcode) to perform various functions discussed herein and may optionally be driven by firmware and/or software.

Alternatively, according to exemplary embodiments, each of the implementing module 414, inserting module 416, reinforcement module 418, generating module 420, updating module 422, and the communication module 424 of the ABDM 406 may be implemented by dedicated hardware, or as a combination of dedicated hardware to perform some functions and a processor (e.g., one or more programmed microprocessors and associated circuitry) to perform other functions.

According to exemplary embodiments, each of the implementing module 414, inserting module 416, reinforcement module 418, generating module 420, updating module 422, and the communication module 424 of the ABDM 406 may be called via corresponding API.

The process may be executed via the communication module 424 and the communication network 410, which may comprise plural networks as described above. For example, in an exemplary embodiment, the various components of the ABDM 406 may communicate with the server 404, and the database(s) 412 via the communication module 424 and the communication network 410. Of course, these embodiments are merely exemplary and are not limiting or exhaustive.

For example, according to exemplary embodiments, the implementing module 414 may be configured to implement a decomposition algorithm that allows a solution of a comparatively larger linear programming problems that have a special block structure. The interesting module 416 may be configured to insert a reinforcement learning agent within a framework of the decomposition algorithm. The generating module 420 may be configured to generate, in response to inserting the reinforcement learning agent, master problem decisions in place of an NP-hard MIMP.

According to exemplary embodiments, the special block structure may occur in applications that may include stochastic programming as uncertainty is represented with scenarios.

According to exemplary embodiments, the decomposition algorithm is BD algorithm that decomposes stochastic optimization problems on the basis of scenario independence into BD sub-problems.

According to exemplary embodiments, the implementing module 414 may be configured to implement cuts from the BD sub-problems. The communication module 424 may be configured to notify, in response to implementing the cuts, selection of future master problem (MP)-agent solutions. The inserting module 416 may be configured to combine the MP-agent solutions within a BD framework.

According to exemplary embodiments, the reinforcement learning agent may be configured to generate solutions to unseen problems after learning a loss of decisions in similar stochastic environments.

According to exemplary embodiments, the updating module 422 may be configured to update behaviors of the reinforcement learning agent based on learning the loss of decisions in similar stochastic environments.

According to exemplary embodiments, for each iteration, a decision to use the reinforcement learning agent in place of the MIMP is drawn from a Bernoulli distribution with a control parameter, and when a value of “1” is returned from the Bernoulli distribution, the reinforcement learning agent is used to generate global decisions, and when a value of “0” is returned from the Bernoulli distribution, the MIMP is run and an optimality gap is confirmed, but the disclosure is not limited thereto. For example, the use of a Bernoulli distribution can be replaced by any other selection heuristic that switches between the RL agent and the MIMP without departing from the scope of the present disclosure.

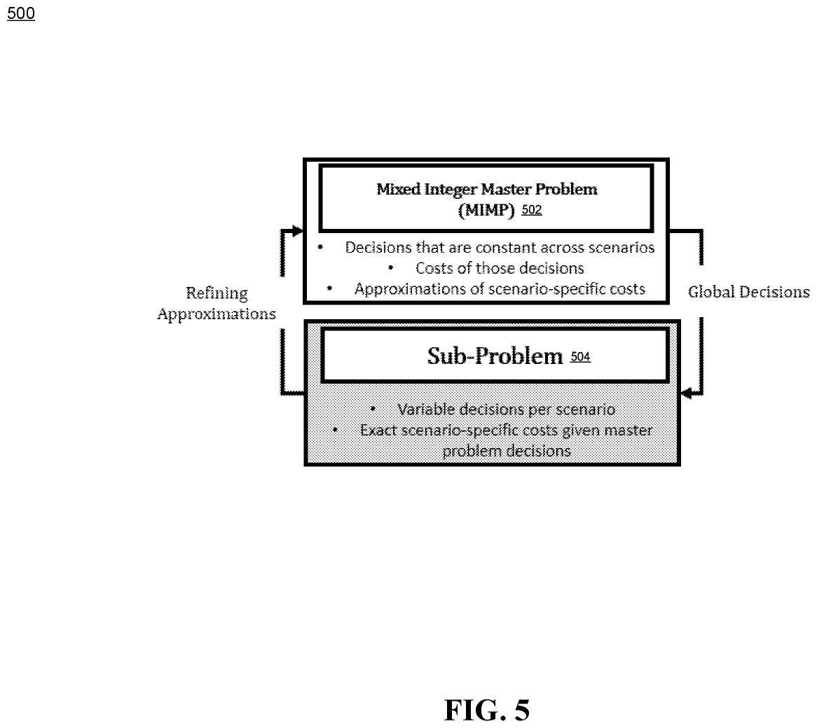

Functionalities of the ABDM 406 are further detailed below with respect to FIGS. 5-10.

A widely used form of stochastic optimization is Sample Average Approximation (SAA). SAA aims to approximate loss over the distribution of possible scenarios using simulation. In SAA, R scenarios are simulated, with each simulation yielding its own deterministic sub-problem with a loss function f(x, w, Dᵣ), where x is a set of global decisions (universal across all scenarios), w is a cost vector, and Dᵣ is a set of scenario-specific parameters. The total loss of the problem is then computed as an average of the loss across all scenarios,

$$ℓ ( x ) = \frac{1}{R} {\sum }_{∀ r ∈ R} f ( x , w , {D}_{r} ) \qquad ( 1 )$$

Despite success in a number of optimal planning domains, the struggles of scaling SO problems are well documented. For example, when solving stochastic vehicle routing problems, practitioners commonly resort to heuristics as exact methods become intractable. To combat scalability issues, decomposition methods are commonly used to solve large-scale SO problems. The instant disclosure introduces the principles of Benders Decomposition. Consider an SAA problem of the form:

$${min}_{x , y} {c}^{T} x + \frac{1}{R} {\sum }_{∀ r ∈ R} {w}^{T} {y}_{r} \qquad ( 2 )$$

$$subject to$$

$$Ax = b \qquad ( 3 )$$

$$Bx + {D}_{r} {y}_{r} = g , \qquad ( 4 )$$

$$∀ r ∈ R$$

$$x ∈ ℤ , {y}_{r} ∈ {ℤ}^{+} , \qquad ( 5 )$$

$$∀ r ∈ R$$

where x is again our set of global decisions, A, b, and B are parameters that define constraints on x, c is the cost of global decisions, Dᵣ and g are scenario-specific parameters, yᵣ is a set of decisions made independently within each scenario, and w is a cost applied to each scenario-specific decision. In this formulation, w^{T}yᵣ is equivalent to ƒ(x, w, Dᵣ) in (1). The first step of BD implemented by the ABDM 406 is to separate the global decision variables x and scenario-specific decision variables yᵣ. This leaves with a master problem

$$\{ {min}_{x , θ} {c}^{T} x + \frac{1}{R} {\sum }_{∀ r ∈ R} {θ}_{r} : Ax = b , x ∈ {ℤ}^{+} \} \qquad ( 6 )$$

and a collection of R sub-problems, where for each r∈R, the following formula is achieved

$$\{ {min}_{{y}_{r}} {w}^{T} {y}_{r} : {D}_{r} {y}_{r} = g - {Bx}^{*} , {y}_{r} ∈ {ℝ}^{+} \} \qquad ( 7 )$$

The sub-problems accept a fixed x* based on the solution to (6), and are solved to obtain optimal sub-problem decisions yᵣ. Note that BD introduces a set of auxiliary variables θᵣ for all r E R to the master problem (6). This auxiliary variable, frequently called the recourse variable, is responsible for tracking an approximation of the sub-problem costs that have been moved to (7). According to exemplary embodiments, it is assumed that the sub-problem is always feasible. This is not a necessary assumption, but simplifies the following description of BD.

Note that integrality on yᵣ has been relaxed in the sub-problems. This relaxation is necessary for Benders decomposition, and only possible when a) the sub-problem variables were not discrete to begin with or b) the decomposition results in a totally-unimodular sub-problem structure. Taking the dual of the sub-problem, the following formula is generated:

$$\{ {min}_{{q}_{r}} {q}_{r}^{T} ( g - {Bx}^{*} ) : {q}_{r}^{T} {D}_{r} \leq w \} \qquad ( 8 )$$

The dual sub-problem has three essential properties. First, through strong duality the optimal value of (8) is equivalent to the optimal value of (7) at x*. Second, the objective function (8) is linear with respect to the master problem decisions x. And lastly, with the optimal dual values of qᵣ* one can establish the following via weak duality.

$$\{ {min}_{{y}_{r}} {w}^{T} {y}_{r} : {D}_{r} {y}_{r} = g - Bx \} \geq {q}_{r}^{* T} ( g - Bx ) , ∀ x ∈ ℝ , ∀ w ∈ ℝ \qquad ( 9 )$$

With these traits established, one can see that the optimal SP objective qᵣ*T(g−Bx) can be included as a valid constraint on θᵣ in the MIMP, serving as a sub-gradient approximation of the SP costs. For each SP solution, the updating module 422 can update the MP with the valid constraint of θᵣ≥ qᵣ*^{T}(g−Bx) and re-solve for a new x. This process is repeated until the SP's do not offer any strengthening constraints on θᵣ, indicating convergence and full approximation of SP loss. FIG. 5 offers a visual representation of this process.

Conventional Benders decomposition relies on an MIMP. The complexity of this MIMP scales linearly with time, as new constraints are added. Often, many iterations are required to generate a good approximation of the convex loss. As a result, Benders can take a long time to converge.

According to exemplary embodiments, FIG. 5 illustrates an exemplary iterative procedure 500 of Benders decomposition, alternating between MIMP 502 (equation (6) above) and SP 504 (equation (8) above) as implemented by the platform and language agnostic ABDM 406 of FIG. 4 in accordance with an exemplary embodiment.

### Reinforcement Learning (RL)

RL, according to exemplary embodiments, is typically based on the Markov Decision Process (MDP) framework. The MDP is a mathematical framework used for modeling decision-making problems where the outcomes are partly random and partly controllable. This can be defined by a tuple [symbol] S, A, T, R [symbol] where S is the set of states, A is the set of actions, T is a set of transition probabilities from state s to the next state s′ upon taking action a, and R is the reward function. In temporal environments, one can adopt the notation of sₜ∈S, aₜ∈A for the state and action of a given time step t.

In RL, an agent attempts to learn the optimal action given a state. Performance is measured by the collective rewards over future states and actions. The behaviors of the agent are updated based on prior experience, and can collectively be defined by a policy, a˜π(s). RL algorithms can be broadly partitioned into two classes: value-based and policy based. In a value-based implementation, the policy a˜π(s) is selected using value-function approximation methods, where

$${Q}^{π} ( {s}_{t} , {a}_{t} ) = {\sum }_{∀ j ∈ T} {𝔼}_{{s}_{t + 1} , {a}_{t + 1} , …} [ {γ}_{t} ℛ ( {s}_{t + j} , {a}_{t + j} ) ] \qquad ( 10 )$$

is the expected reward of an action, γₜ is a discount rate placed on future reward, and an optimal policy is deterministically selected based on argmax_{π}Q^{π}.

Rather than estimating the value-function Q and generating deterministic policies based on actions that maximize the approximate Q-function, policy-based reinforcement learning implemented by the ABDM 406 optimizes a functional representation of the policy a˜π(s). The ABDM 406 defines the functional representation of a policy as a˜πβ(s), where β is a set of learned parameters. Importantly, in policy-based learning the agent optimizes the parameters β to generate a stochastic policy. This stochastic policy respects the fact that the reward for an action may not be deterministic, and consequentially a single best action may not exist.

Known optimization procedure for policy-based RL may update the parameter set β via an estimate of the policy gradient. A known powerful variation of policy-based optimization may also be introduced to avoid detrimentally large policy updates. For example, in this known version of policy-based optimization, the policy changes are regulated by limiting the reward of policy variation. This known method, titled Proximal Policy Optimization (PPO), updates the objective function to clip the reward of policy updates where the ratio

$$\vert \frac{{π}_{β}^{new} ( {a}_{t} \vert {s}_{t} )}{{π}_{β}^{old} ( {a}_{t} \vert {s}_{t} )} \vert$$

extends beyond some ϵ. A known variation of PPO combines policy-based and value-based RL by optimizing both a policy and a value function, in what is known as actor-critic PPO, where the value function can be used to obtain better estimates of the policy gradient.

Policy-based RL is a more applicable form of RL for our proposal, as it enables a set of diverse actions to be generated for a given state. Given a requirement for non-deterministic actions, the ABDM, according to exemplary embodiments, implements an actor-critic PPO RL algorithm with a multi-layer neural network serving as our agent, which includes a policy output head and value output head. The parameter set of this network, β, defines our policy πβ.

### Accelerating Benders Decomposition

According to exemplary embodiments, with background on BD and RL provided, the ABDM 406 implements a method of accelerating Benders decomposition. First, specifics on how an MP-agent is inserted within the BD framework will be discussed. Then, three possible mechanisms for selecting actions from the MP-agent will be introduced. Lastly, a more thorough coverage of the theoretical benefits that the MP-agent provides, and known deficiencies of BD that it addresses.

### RL-Master

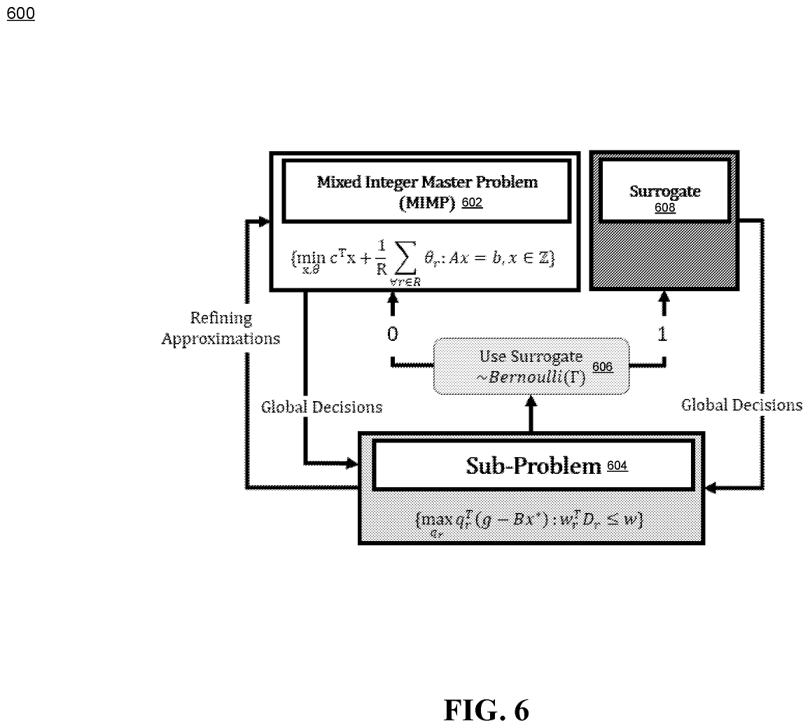

Recall the iterative procedure outlined in FIG. 5. The SP's can be solved efficiently using any standard LP solver, but each iteration calls back to a complex MIMP. Not only is the MIMP N P-hard, but its complexity scales linearly with the number of iterations as a new constraint is added from the SP. Given these mechanics, there is a strong desire to; a) increase the speed of each master problem iteration and b) decrease the total number of calls to the MIMP required to form a strong approximation of the loss. According to exemplary embodiments, the ABDM 406 may achieve both results by periodically introducing an RL agent, titled MP-agent, in place of the MIMP to generate master problem solutions (see, e.g., FIG. 6). For discussion purposes, this framework can be referred to as RL-Master.

FIG. 6 illustrates an exemplary iterative procedure 600 of RL-Master as implemented by the platform and language agnostic ABDM 406 of FIG. 4 in accordance with an exemplary embodiment.

According to exemplary embodiments, this modified schema that with each iteration, the decision to use the MP-agent in place of the MIMP 602 is drawn from a Bernoulli distribution with a control parameter Γ (i.e., use surrogate 606). If a value of 1 (see, e.g., surrogate 608) is returned from the Bernoulli distribution, the MP-agent is used to generate global decisions. Otherwise, the standard MIMP is run and the optimality gap can be confirmed, but the disclosure is not limited thereto. For example, the use of a Bernoulli distribution can be replaced by any other selection heuristic that switches between the RL agent and the MIMP without departing from the scope of the present disclosure. Regardless of whether the MIMP 602 or MP-agent are used, global decisions are passed to the sub-problem 604 and loss approximating cuts are added.

For example, according to exemplary embodiments, with some probability, the ABDM 406 replaces the expensive MIMP 602 with a fast surrogate model (i.e., surrogate 608) that has learned from past instances. This surrogate model provides fast approximations of the optimal policy. According to exemplary embodiments, the surrogate model may be trained offline, and used for inference online. At each iteration, cuts are added to the MIMP 602. According to exemplary embodiments, the modified algorithm adheres to the convergence principles of Benders.

### Controlling MP-Agent Usage

The MP-agent usage can be controlled within the RL-Master schema in a variety of ways, and disclosed herein, are three forms of control. These variants are aimed at answering 1) How frequently should we use the MP-agent? 2) How can we be sure the MP-agent solutions are useful for convergence? 3) With non-deterministic policies being generated by the MP-agent, how can we decide which policy is best to use? The three methods implemented by the ABDM 406 are a greedy selection, weighted selection, and informed selection. Each of these methods assume the MP-agent has generated a non-deterministic batch of policies for the given environment.

### Greedy Selection

According to exemplary embodiments, the greedy selection process implemented by the ABDM 406 first evaluates every MP-agent solution in a given batch against an expected outcome. At each iteration, the decision to use the MP-agent is made with some probability. If the MP-agent is used, we select the top performing solution from the batch and use it as our MP solution. The solution is then removed from the batch and the process is continued until we reach a desired optimality gap. At this point, the MP-agent is deactivated and BD operates normally until convergence.

### Weighted Selection

Rather than deterministically selecting policies based on their performance against an expectation, the ABDM 406 implements weighted random sampling process. The ABDM 406 utilizes the calculated loss of policy i evaluated against an expected outcome, which is referred to as [symbol] . However, instead of selecting argminᵢ ( [symbol] ᵢ) as in the greedy method, the ABDM 406 creates a probability vector, where

$$p ( i ) = \frac{\frac{1}{\text{?}}}{\sum \text{?} \frac{1}{\text{?}}} .$$

$$\text{?} \text{indicates text missing or illegible when filed}$$

Using this probability vector, the ABDM 406 samples from the batch of policies each time MP-agent is called.

### Informed Selection

According to exemplary embodiments, this approach incorporates feedback from the BD sub-problems. With informed selection, MP-agent solutions are selected using the constraint set currently placed on θ. The benefit of utilizing the constraint matrix to select MP-agent solutions is that these constraints inherently motivate exploration to either a) minimal or b) poorly approximated regions of the convex loss. Given final convergence is defined by a binding subset of these constraints, it is necessary to explore these minimal or poorly approximated regions.

According to exemplary embodiments, the ABDM 406 implements a constraint matrix Aᵣ∈R^{I×M} which contains the sub-gradients applied to ordering decisions, a constraint matrix Bᵣ∈R^{I×M} which contains the sub-gradients applied to scheduling decisions, and a row vector of constant values cᵣ∈R^{M} that is added to each sub-gradient approximation. I refers to the iteration number of BD, T refers to the time horizon, and r refers to the scenario.

According to exemplary embodiments, each iteration generates a new set of sub-gradient approximations that are added to the matrix. As mentioned, these are the same sub-gradients that are applied to θ in the master problem, and are generated using dual sub-problem. On a given iteration, there is a batch of M solutions that have been generated by the MP-agent. Order-up-to quantities for this batch are represented by matrix O∈Z^{T×M} and schedule decisions are represented by matrix S∈{0, 1}^{T×M}. The ABDM 406 first computes the cost approximations of ordering for each MP-agent solution (given as OCAᵣ∈R^{I×M})

$${OCA}_{r} = {A}_{r} \cdot O \qquad ( 11 )$$

and the schedule cost approximation (given as SCAᵣ∈R^{I×M)})

$${SCA}_{r} = {B}_{r} \cdot S \qquad ( 12 )$$

According to exemplary embodiments, the ABDM 406 then adds the two matrices and the sub-gradient constants to get the total sub-problem cost approximations (TCAᵣ∈R^{I×M}) for each MP-agent solution.

$${TCA}_{r} = {OCA}_{r} + {SCA}_{r} + {( {c}_{r} \cdot {1}^{1 \times 1 + 1} )}^{T} \qquad ( 13 )$$

The TCAᵣ matrix contains approximations of the sub-problem loss for each of the M solutions, generated by each of the I constraints currently placed on θr. The ABDM 406 utilizes the maximum row-wise value for each column M as the approximated cost. In LP terms, this maximum value relates to the binding constraint on θr in the MIMP, and is thus the true approximation of cost at that point. This approximation may be represented as [symbol] ₘᵣ.

$${ℓ}_{m , r} = {max}_{∀ i} {( {TCA}_{r} )}_{im} \qquad ( 14 )$$

Now the ABDM 406 fully approximates the expected cost for each of the M solutions by taking an average across all R scenarios, and adding the fixed costs (denoted fₘ).

$${ℓ}_{m} = \frac{1}{R} {\sum }_{∀ r ∈ R} {ℓ}_{m , r} + {f}_{m} \qquad ( 15 )$$

the MP-agent solution that minimizes the problem

$$arg {min}_{m} {ℓ}_{m} \qquad ( 16 )$$

is then taken as the MP solution, and passed to the sub-problem for constraint generation.

According to exemplary embodiments, the benefits of using an MP-agent in place of the MIMP is based on two central principles, but the disclosure is not limited thereto: i) the time required to generate solutions from a pre-trained MP-agent agent is negligible compared to the time required to solve a large scale MIP; and ii) the MP-agent has learned a policy TB for the stochastic environment. As a result, sub-problem loss is expressed in MP-agent solutions regardless of how well θᵣ approximates SP loss. This means that even early iterations of the MP-agent will be highly reflective of sub-problem loss.

According to exemplary embodiments, the MP-agent mitigates this major issue by generating global decisions that reflect an understanding of their associated sub-problem loss without requiring strong loss approximations on θᵣ. As a result, initial global decisions generated by the MP-agent are localized to the minimal region and cuts can quickly approximate the minimum of the convex loss. These two fundamental benefits are the basis for a 30 percent (30%) reduction in run-times, observed in experiments with the working example that follows.

### Nonlimiting Working Example

According to exemplary embodiments, an inventory management problem (IMP) as a working example to be used through the remainder of the paper and experiments. In the proposed IMP, it is assumed that the required solutions must a) choose a delivery schedule from a finite set, b) decide an order-up-to amount (order=order-up-to−current inventory) for each order day, and c) place costly emergency orders if demand cannot be met with current inventory. For simplicity, consider a single-item, single-location ordering problem where there is a requirement to satisfy all demand using either planned schedules, or more costly just-in-time emergency orders. The demand estimate is generated using a forecast model with an error term from an unknown probability distribution. A nonlimiting exemplary application of IMP formulations is that of the management of cash inventory across ATM networks.

### SO Formulation and Decomposition

To model the IMP as a SO mixed-integer problem, according to exemplary embodiments, the ABDM 406 defines the following notation. Let T be set of days, indexed by t. R denotes set of scenarios r, and S defines a finite set of schedules s; h is introduced as the holding cost of an item (per unit-of-measure, per day), e as the cost of emergency services (per unit), q as the penalty applied to over-stocking (per unit over-stocked), and fₛ as the fixed cost of a schedule. Capacity is defined by m and starting inventory by y. The parameter wₛₜ indicates whether schedule s orders on day t. Demand on day t under scenario r is nt.

The decision space is defined by seven variables. The decision to use schedule s is made using variable uₛ∈{0, 1}. The order-up-to amount is decided by aₜ∈Z+, and kₜᵣ∈Z is the required order quantity to meet the order-up-to amount. Inventory on hand is monitored by dₜᵣ∈Z+, the units of holding space required to stock the inventory is pₜᵣ∈Z+, the required emergency order quantity is oₜᵣ∈Z+, and vₜᵣ∈Z+ is the number of units that inventory is over-filled by (all defined ∀t∈T, ∀r∈R).

$$min {\sum }_{∀ s ∈ S} ( {u}_{s} {f}_{s} ) + \frac{1}{R} {\sum }_{∀ r ∈ R} {\sum }_{∀ t ∈ T} ( {p}_{tr} h + {o}_{tr} e + {v}_{tr} q ) \qquad ( 17 )$$

$$subject to :$$

$${d}_{tr} = y - {n}_{tr} + {k}_{tr} - {v}_{tr} + {o}_{tr} , t = 0 , ∀ r ∈ R \qquad ( 18 )$$

$${d}_{tr} = {d}_{t - 1 , r} + {k}_{tr} - {n}_{tr} + {o}_{tr} - {v}_{tr} , ∀ t ∈ \{ 1 , … , T \} , ∀ r ∈ R \qquad ( 19 )$$

$${p}_{tr} \geq y + {k}_{tr} - {v}_{tr} , t = 0 , ∀ r ∈ R \qquad ( 20 )$$

$${p}_{tr} \geq {a}_{t} , ∀ t ∈ \{ 1 , … , T \} , ∀ r ∈ R \qquad ( 21 )$$

$${p}_{tr} \geq {p}_{t - 1 , r} - {a}_{t} , ∀ t ∈ \{ 1 , … , T \} , ∀ r ∈ R \qquad ( 22 )$$

$$y + {k}_{tr} - {v}_{tr} \leq M , t = 0 , ∀ r ∈ R \qquad ( 23 )$$

$${d}_{t - 1 , r} + {k}_{tr} - {v}_{tr} \leq M , ∀ t ∈ \{ 1 , … , T \} , ∀ r ∈ R \qquad ( 24 )$$

$${k}_{tr} = {a}_{t} - y {\sum }_{∀ s ∈ S} {u}_{s} {w}_{st} \qquad ( 25 )$$

$${k}_{tr} \geq {a}_{t} - {d}_{t - 1 , r} , ∀ t ∈ \{ 1 , … , T \} , ∀ r ∈ R \qquad ( 26 )$$

$${k}_{tr} \leq {a}_{t} - {d}_{t - 1 , r} + ( 1 - {\sum }_{∀ s ∈ S} {u}_{s} {w}_{st} ) M , ∀ t ∈ \{ 1 , … , T \} , ∀ r ∈ R \qquad ( 27 )$$

$${k}_{tr} \leq {a}_{t} , ∀ t ∈ T , ∀ r ∈ R \qquad ( 28 )$$

$${k}_{tr} \geq - {\sum }_{∀ s ∈ S} {u}_{s} {w}_{st} \times M , ∀ t ∈ T , ∀ r ∈ R \qquad ( 29 )$$

$${v}_{tr} \leq {a}_{t} , ∀ t ∈ T , ∀ r ∈ R \qquad ( 30 )$$

$${a}_{t} \leq {\sum }_{∀ s ∈ S} {u}_{s} {w}_{st} \times M , ∀ t ∈ T \qquad ( 31 )$$

$${\sum }_{∀ s ∈ S} {u}_{s} = 1 \qquad ( 32 )$$

The objective (17) minimizes the cost of the planned schedule, and the expected holding cost, emergency order costs, and over-fill costs across the R scenarios. Flow constraints (18) and (19) balance inflow and outflow of inventory through demand and deliveries. The holding cost is enforced by constraints (20), (21), and (22). Constraints (23) and (24) mandate that inventory cannot be filled beyond its capacity. Lastly, constraints (25), (26), (27), (28), (29), and (31) ensure an order exactly fills the inventory to the optimal order-up-to-amount, and that orders are only placed on scheduled days. (32) guarantees exactly one schedule is selected.

For BD, it is noted that a and u are schedule and order-up-to decisions that must be made the same across all scenarios. As a result, a, u, (31), and (32) are contained in the MIMP while the remaining decision variables and constraints are delegated to the scenario specific sub-problems. For brevity, the primal sub-problem formulation is omitted, and the cut-generating dual sub-problem formulation is directly introduced. The ABDM 406 first defines the dual variables in line with their related constraints: αₜ(∀t∈T) [(18), (19)], ϕₜ(∀t∈T) [(23), (24)], γₜ(∀t∈T) [(20), (21)], ωₜ(∀t∈{1, . . . , T}) (22), ξ⁰ (25), ξₜ^{lb}(∀t∈{1 . . . , T}) (26), ξₜ^{ub}(∀t E {1, . . . , T}) (27), σₜ(∀t∈T) (28), πₜ(∀t∈T) (29), βₜ(∀t∈T) (30). These dual variables, and the dual problems that they construct, is solved independently for each scenario r in R. As a result, they are affixed with the subscript r in the following formulation. The ABDM 406 also utilizes a parameter vector θ to the master problem, which serves as an abstraction of the sub-problem costs approximated by linear constraints.

### Master Problem

$${min}_{a , u , θ} {\sum }_{∀ s ∈ S} ( {u}_{s} \times {f}_{s} ) + \frac{1}{R} {\sum }_{∀ r ∈ R} {θ}_{r} \qquad ( 33 )$$

$$s . t .$$

$${a}_{t} \leq {\sum }_{∀ s ∈ S} {u}_{s} {w}_{st} \times M , ∀ t ∈ T \qquad ( 34 )$$

$${\sum }_{∀ s ∈ S} {u}_{s} = 1 \qquad ( 35 )$$

$${θ}_{r} \geq 0 , ∀ r ∈ R \qquad ( 36 )$$

### Dual Sub-Problem (Solved Independently for Each Scenario r)

$${max}_{α , ϕ , {ξ}^{0} , {ξ}^{l b} , {ξ}^{ub} , σ , π} {α}_{0 r} ( y - {n}_{0} r ) + {γ}_{0 r} y + {ξ}_{r}^{0} ( {a}_{0} - y \times {\sum }_{∀ s ∈ S} {u}_{s} {w}_{s 0} ) + {ϕ}_{0 r} ( m - y ) + {\sum }_{t = 1}^{T} ( - {α}_{tr} {n}_{tr} + {γ}_{tr} {a}_{t} - {ω}_{tr} {a}_{t} + {ϕ}_{tr} m + {ξ}_{tr}^{l b} {a}_{tr} + {ξ}_{tr}^{u b} ( {a}_{tr} + ( 1 - {\sum }_{∀ s ∈ S} {u}_{s} {w}_{s t} ) m ) ) + {\sum }_{∀ t ∈ T} ( {ϕ}_{tr} {a}_{t} + {σ}_{tr} {a}_{t} - {π}_{tr} ( {\sum }_{∀ s ∈ S} {u}_{s} {w}_{s t} \times m ) ) \qquad ( 41 )$$

$$s . t .$$

$${α}_{tr} \leq 0 , t = T \qquad ( 42 )$$

$${α}_{tr} - {α}_{t + 1 , r} + {ϕ}_{t + 1 , r} + {ξ}_{t + 1 , r}^{ub} + {ξ}_{t + 1 , r}^{l b} \leq 0 , ∀ t ∈ \{ 0 , … , T - 1 \} \qquad ( 43 )$$

$${γ}_{tr} - {ω}_{t + 1 , r} \leq h , t = 0 \qquad ( 44 )$$

$${γ}_{tr} + {ω}_{tr} \leq h , t = T \qquad ( 45 )$$

$${γ}_{tr} - {ω}_{t + 1 , r} + {ω}_{tr} \leq h , ∀ t ∈ \{ 1 , … , T - 1 \} \qquad ( 46 )$$

$${α}_{tr} + {ϕ}_{tr} - {ϕ}_{tr} + {γ}_{tr} \leq q , t = 0 \qquad ( 47 )$$

$${α}_{tr} + {ϕ}_{tr} - {ϕ}_{tr} \leq q , ∀ t ∈ \{ 1 , … , T \} \qquad ( 48 )$$

$$- {α}_{tr} \leq p , ∀ t ∈ T \qquad ( 49 )$$

$${ξ}_{r}^{0} - {γ}_{tr} + {ϕ}_{tr} - {α}_{tr} + {σ}_{tr} + {π}_{tr} = 0 , t = 0 \qquad ( 50 )$$

$${ξ}_{tr}^{l b} + {ξ}_{tr}^{u b} + {ϕ}_{tr} - {α}_{tr} + {σ}_{tr} + {π}_{tr} = 0 , ∀ t ∈ \{ 1 , … , T \} \qquad ( 51 )$$

Referring back to the polyhedron defined by master problem constraints at iteration i as Pᵢ. The master problem generates optimal decisions a* and u* given the current approximation of sub-problem costs θ. The objective function of the dual sub-problem (referred to as L (a, u, r), where r is the scenario) is updated with a* and u*, and the sub-problem is solved. Recalling the mechanics of BD, the optimal solution to the dual sub-problem has two valuable properties: a) as a numeric value it defines the true scenario specific costs, and b) as a function it offers a sub-gradient on θ. The master problem polyhedron is then updated to Pᵢ+1=Pᵢ∩{u, a, θ:θr≥ L*(a, u, r), ∀r∈R}, where L*(a, u, r) refers to the optimized loss function of the sub-problem iteration. This process is repeated until convergence, with each iteration of the master problem being solved over a more refined approximation of sub-problem costs.

### RL Formulation

The state of our IMP is represented by the tuple sₜ= [symbol] d, h, e, q, m, μ, σ, w, o, r [symbol] ∈S, where t is a time step over the horizon T. Parameters d, h, e, q, w, and m directly follow the definitions introduced in the SO Formulation and Decomposition section. State parameters that are not yet defined include u as the expected demand, and σ as the standard deviation of demand. A vector o tracks orders over the time horizon T. All future orders are set to zero, past orders are taken from past actions. Similarly, a vector r tracks the forecast errors from past observations. All future observations are set to zero, and populated as the MDP is steps through time and events are observed.

The actions are represented by [symbol] kₜ, uₜ [symbol] ∈A which denotes (a) the quantity to order, and (b) the schedule to adhere to, at time t respectively. Decisions are of dimension kₜ∈ {0, 1} 81 and uₜ∈{0, 1} 170, defining 81 possible discrete order quantities and 169 possible schedules. Note that the schedule must be determined at the beginning of the horizon, and thus only uₜ=0 is relevant. This is enforced through action masking and for simplicity one can refer to uₜ=0 as u. The reward is negative cost, as defined by the objective (17).

As previously mentioned, a PPO algorithm is optimized using a multi-layer neural network as our agent. The parameters of this network are defined by β and our policy by π_{β}(sₜ, aₜ). The network inputs (the state) are standardized to be mean centered with unit variance, and generate kₜ and uₜ using a feed-forward network with two hidden layers and two linear output layers. The linear output layers return the log-odds that define the stochastic policy of the actor, as well as the continuous value estimate that define the critic.

Initially, the agent is presented with so and must select a scheduling action to take. This scheduling action, u, relates to a binary vector w ∈{0, 1}^{T} that defines whether an order is possible on day t. If wₜ=1, an order can be placed, otherwise the agent cannot order. This schedule now becomes part of the state-space, over-writing the initial zero vector w.

With the schedule defined, the agent must generate a second action for state s₀; this time selecting an order amount. The repeated visitation of state s₀ is necessary as the selected schedule w has now become part of the state. While not temporally shifted, the state has changed. Throughout the remaining states, if wₜ=1 the agent places an order, else the order quantity is masked and the environment updates to s₁.

After so, the agent sequentially traverses the horizon T. With each time step, an ordering decision is made and either accepted or masked depending on the schedule vector w. Updates to the state include population of order quantities, residual updates, and an update of the inventory on hand based on observed demand and order amounts. To retrieve the order-up-to amounts, denoted as a in the SO Formulation section, the ABDM 406 adds inventory on hand at t−1 to the ordering decision at, if an order is scheduled. After traversing the full horizon T, the agent will have selected a schedule u ∈{0, 1}¹⁶⁹ and have a vector of order-up-to quantities a ∈Z^{T}≥0 from the agent. These two decision vectors, u and a are the essential ingredients required by the BD sub-problem. With these vectors, one can solve (37), generate sub-gradient approximations on θ, and further refine our approximation of true, stochastic, sub-problem cost.

### Exemplary Experiments

To evaluate RL-Master, according to exemplary embodiments, experiments on 153 independent cases of our IMP using real-world data were performed. Each experiment was performed with a sample size of 500 scenarios (R=500). Experiments were run on a 36 CPU, 72 GB RAM c5.9xlarge AWS instance. For solving the integer master problem and linear sub-problems, the ABDM 406 leveraged the CPLEX commercial solver with default settings, allowing for distribution across the 36 CPU machine. Experiment was performed with all three RL solution selection methods: greedy, random, and informed. For informed selection, it was investigated how different levels of RL usage impact convergence. As a benchmark, it was evaluated all of our methods against an accelerated implementation of Benders decomposition, including acceleration methods such as scenario group cuts and partial decomposition.

### Results

All three implementations of RL-Master (greedy, random, and informed) produced faster convergence than the benchmark BD implementation. Greedy implementation performed about 19.43% faster than the baseline, while the informed RL-Master implementation performed about 30.45% faster.

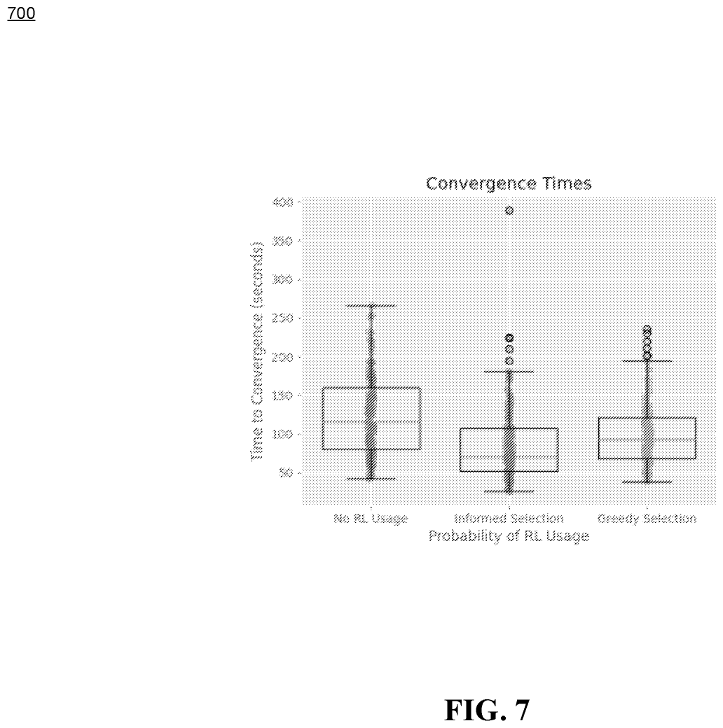

FIG. 7 illustrates an exemplary chart 700 showing convergence instances of BD with and without RL-Master as implemented by the ABDM 406 of FIG. 4 in accordance with an exemplary embodiment.

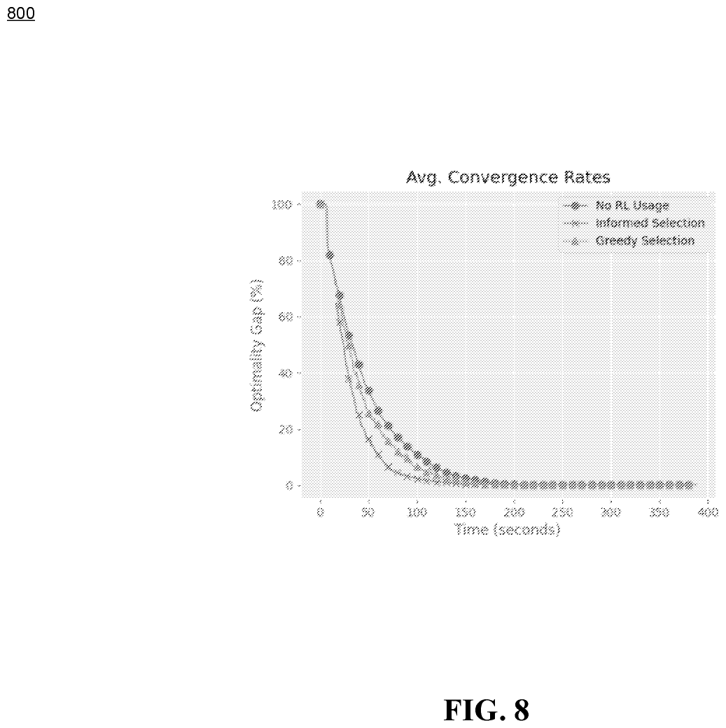

For example, FIG. 8 illustrates an exemplary chart 800 showing convergence rates of BD with and without RL-Master iterative procedure of RL-Master as implemented by the ABDM 406 of FIG. 4 in accordance with an exemplary embodiment.

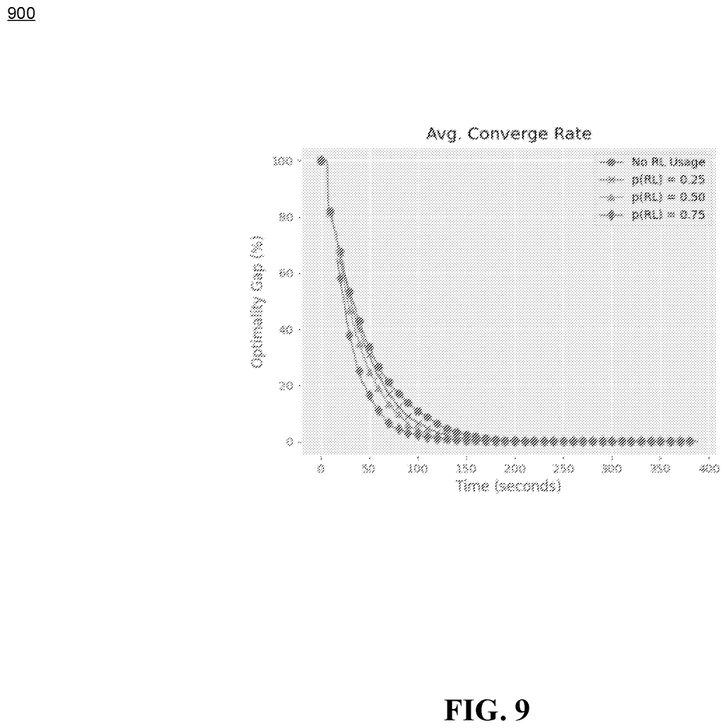

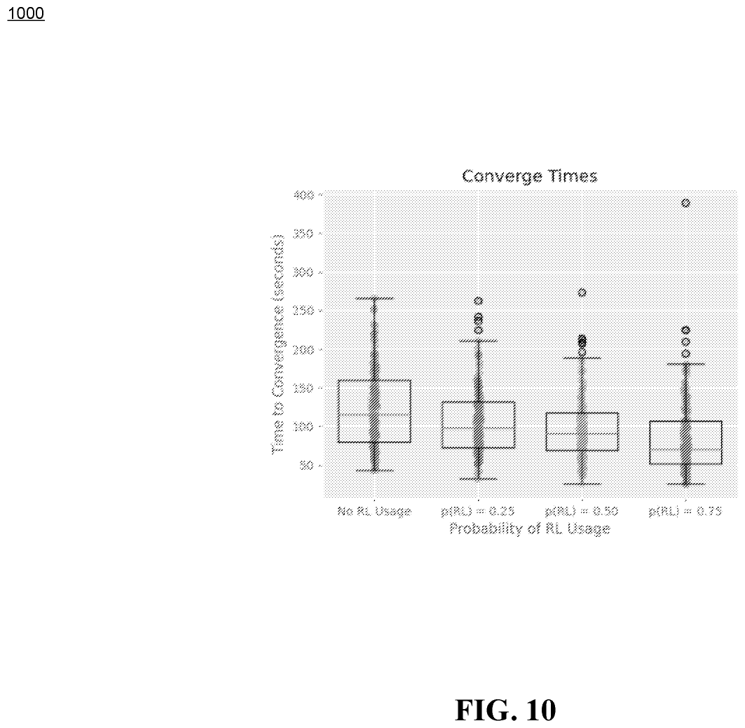

Acknowledging the strong performance of the informed MP-agent selection procedure, it was further experimented with different control parameters regarding the frequency with which the MP-agent is called. The ABDM 406 leveraged three different rate parameters Γ that control whether to use the MP-agent ([0, 1]˜ Bernoulli (Γ)). It was experimented with Γ=0.25, 0.50, and 0.75. In each experiment, we shut off RL usage once the optimality gap was ≤5%. It was observed in FIGS. 9 and 10 that more frequent RL usage results in improved convergence, with optimal convergence rates being generated by Γ=0.75. When compared to BD without RL acceleration, our accelerated method converges 30.45% faster on average.

For example, FIG. 9 illustrates an exemplary chart 900 showing convergence rates of BD accelerated by an informed MP-agent, with different RL usages as implemented by the ABDM 406 of FIG. 4 in accordance with an exemplary embodiment.

For example, FIG. 10 illustrates an exemplary chart 1000 showing convergence instances of BD accelerated by an informed MP-agent, with different RL usages as implemented by the ABDM 406 of FIG. 4 in accordance with an exemplary embodiment.

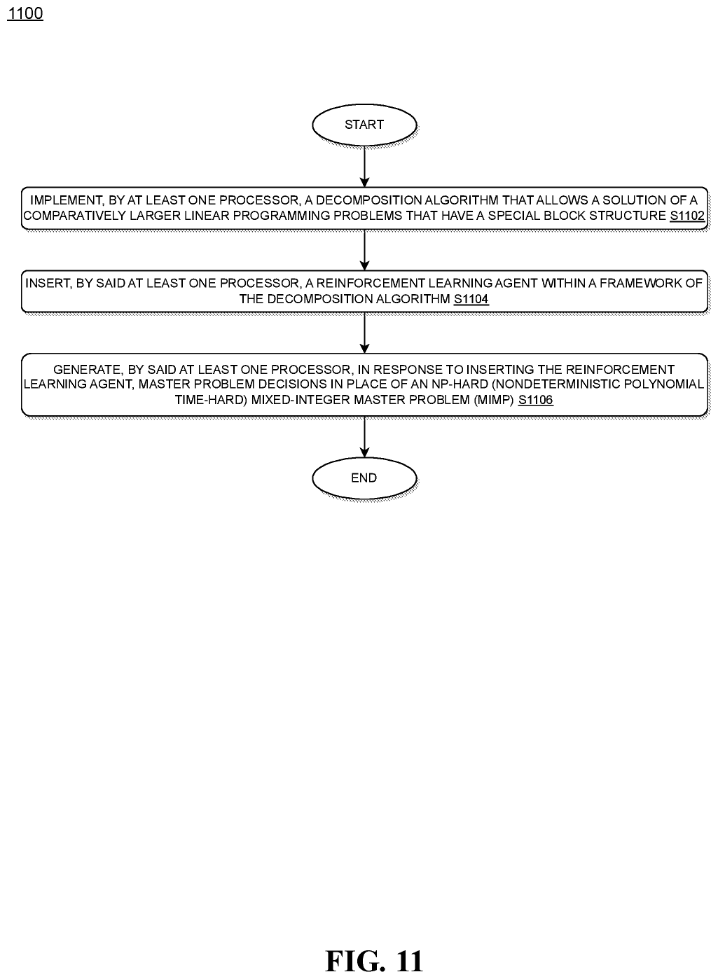

FIG. 11 illustrates an exemplary flow chart of a process 1100 implemented by the ABDM 406 of FIG. 4 for accelerating decomposition via reinforcement learning in accordance with an exemplary embodiment. It will be appreciated that the illustrated process 1100 and associated steps may be performed in a different order, with illustrated steps omitted, with additional steps added, or with a combination of reordered, combined, omitted, or additional steps.

As illustrated in FIG. 11, at step S1102, the process 1100 may include implementing, by at least one processor, a decomposition algorithm that allows a solution of a comparatively larger linear programming problems that have a special block structure.

At step S1104, the process 1100 may include inserting, by said at least one processor, a reinforcement learning agent within a framework of the decomposition algorithm.

At step S1106, the process 1100 may include generating, by said at least one processor, in response to inserting the reinforcement learning agent, master problem decisions in place of an NP-hard MIMP.

According to exemplary embodiments, in the process 1100, the block structure may occur in applications that include stochastic programming as uncertainty is represented with scenarios.

According to exemplary embodiments, in the process 1100, the decomposition algorithm is BD algorithm that decomposes stochastic optimization problems on the basis of scenario independence into BD sub-problems.

According to exemplary embodiments, the process 1100 may further include: implementing cuts from the BD sub-problems; notifying, in response to implementing the cuts, selection of future master problem (MP)-agent solutions; and combining the MP-agent solutions within a BD framework.

According to exemplary embodiments, in the process 1100, the reinforcement learning agent may be configured to generate solutions to unseen problems after learning a loss of decisions in similar stochastic environments.

According to exemplary embodiments, the process 1100 may further include: updating behaviors of the reinforcement learning agent based on learning the loss of decisions in similar stochastic environments.

According to exemplary embodiments, in the process 1100, for each iteration, a decision to use the reinforcement learning agent in place of the MIMP is drawn from a Bernoulli distribution with a control parameter, and when a value of “1” is returned from the Bernoulli distribution, the reinforcement learning agent is used to generate global decisions, and when a value of “0” is returned from the Bernoulli distribution, the MIMP is run and an optimality gap is confirmed, but the disclosure is not limited thereto. For example, the use of a Bernoulli distribution can be replaced by any other selection heuristic that switches between the RL agent and the MIMP without departing from the scope of the present disclosure.

According to exemplary embodiments, the ABDD 402 may include a memory (e.g., a memory 106 as illustrated in FIG. 1) which may be a non-transitory computer readable medium that may be configured to store instructions for implementing a platform and language agnostic ABDM 406 for accelerating decomposition via reinforcement learning as disclosed herein. The ABDD 402 may also include a medium reader (e.g., a medium reader 112 as illustrated in FIG. 1) which may be configured to read any one or more sets of instructions, e.g., software, from any of the memories described herein. The instructions, when executed by a processor embedded within the ABDM 406, or within the ABDD 402, may be used to perform one or more of the methods and processes as described herein. In a particular embodiment, the instructions may reside completely, or at least partially, within the memory 106, the medium reader 112, and/or the processor 104 (see FIG. 1) during execution by the ABDD 402.

According to exemplary embodiments, the instructions, when executed, may cause a processor embedded within the ABDM 406 or the ABDD 402 to perform the following: implementing a decomposition algorithm that allows a solution of a comparatively larger linear programming problems that have a special block structure; inserting a reinforcement learning agent within a framework of the decomposition algorithm; and generating, in response to inserting the reinforcement learning agent, master problem decisions in place of an NP-hard MIMP. According to exemplary embodiments, the processor may be the same or similar to the processor 104 as illustrated in FIG. 1 or the processor embedded within ABDD 202, ABDD 302, ABDD 402, and ABDM 406.

According to exemplary embodiments, the instructions, when executed, may cause the processor 104 to further perform the following: implementing cuts from the BD sub-problems; notifying, in response to implementing the cuts, selection of future MP-agent solutions; and combining the MP-agent solutions within a BD framework.

According to exemplary embodiments, the instructions, when executed, may cause the processor 104 to further perform the following: updating behaviors of the reinforcement learning agent based on learning the loss of decisions in similar stochastic environments, wherein for each iteration, a decision to use the reinforcement learning agent in place of the MIMP is drawn from a Bernoulli distribution with a control parameter, and when a value of “1” is returned from the Bernoulli distribution, the reinforcement learning agent is used to generate global decisions, and when a value of “0” is returned from the Bernoulli distribution, the MIMP is run and an optimality gap is confirmed, but the disclosure is not limited thereto. For example, the use of a Bernoulli distribution can be replaced by any other selection heuristic that switches between the RL agent and the MIMP without departing from the scope of the present disclosure.

According to exemplary embodiments as disclosed above in FIGS. 1-11, technical improvements effected by the instant disclosure may include a platform for implementing a platform and language agnostic accelerated Benders decomposition module for accelerating decomposition via reinforcement learning, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for accelerating decomposition via reinforcement learning by utilizing one or more processors along with allocated memory, the method comprising:
implementing, by at least one processor, a decomposition algorithm that allows a solution of a comparatively larger linear programming problems that have a special block structure;
inserting, by said at least one processor, a reinforcement learning agent within a framework of the decomposition algorithm; and
generating, by said at least one processor, in response to inserting the reinforcement learning agent, master problem decisions in place of an NP-hard (nondeterministic polynomial time-hard) mixed-integer master problem (MIMP).

2. The method according to claim 1, wherein the block structure occurs in applications that include stochastic programming as uncertainty is represented with scenarios.

3. The method according to claim 2, wherein the decomposition algorithm is benders decomposition (BD) algorithm that decomposes stochastic optimization problems on the basis of scenario independence into BD sub-problems.

4. The method according to claim 3, further comprising:
implementing cuts from the BD sub-problems;
notifying, in response to implementing the cuts, selection of future master problem (MP)-agent solutions; and
combining the MP-agent solutions within a BD framework.

5. The method according to claim 2, wherein the reinforcement learning agent is configured to generate solutions to unseen problems after learning a loss of decisions in similar stochastic environments.

6. The method according to claim 5, further comprising:
updating behaviors of the reinforcement learning agent based on learning the loss of decisions in similar stochastic environments.

7. The method according to claim 1, wherein for each iteration, a decision to use the reinforcement learning agent in place of the MIMP is drawn from a Bernoulli distribution with a control parameter, and when a value of “1” is returned from the Bernoulli distribution, the reinforcement learning agent is used to generate global decisions, and when a value of “0” is returned from the Bernoulli distribution, the MIMP is run and an optimality gap is confirmed.

8. A system for accelerating decomposition via reinforcement learning, the system comprising:
a processor; and
a memory operatively connected to the processor via a communication interface, the memory storing computer readable instructions, when executed, causes the processor to:
implement a decomposition algorithm that allows a solution of a comparatively larger linear programming problems that have a special block structure;
insert a reinforcement learning agent within a framework of the decomposition algorithm; and
generate, in response to inserting the reinforcement learning agent, master problem decisions in place of an NP-hard (nondeterministic polynomial time-hard) mixed-integer master problem (MIMP).

9. The system according to claim 8, wherein the block structure occurs in applications that include stochastic programming as uncertainty is represented with scenarios.

10. The system according to claim 9, wherein the decomposition algorithm is benders decomposition (BD) algorithm that decomposes stochastic optimization problems on the basis of scenario independence into BD sub-problems.

11. The system according to claim 10, wherein the processor is further configured to:
implement cuts from the BD sub-problems;
notify, in response to implementing the cuts, selection of future master problem (MP)-agent solutions; and
combine the MP-agent solutions within a BD framework.

12. The system according to claim 9, wherein the reinforcement learning agent is configured to generate solutions to unseen problems after learning a loss of decisions in similar stochastic environments.

13. The system according to claim 12, wherein the processor is further configured to:
update behaviors of the reinforcement learning agent based on learning the loss of decisions in similar stochastic environments.

14. The system according to claim 8, wherein for each iteration, a decision to use the reinforcement learning agent in place of the MIMP is drawn from a Bernoulli distribution with a control parameter, and when a value of “1” is returned from the Bernoulli distribution, the reinforcement learning agent is used to generate global decisions, and when a value of “0” is returned from the Bernoulli distribution, the MIMP is run and an optimality gap is confirmed.

15. A non-transitory computer readable medium configured to store instructions for accelerating decomposition via reinforcement learning, the instructions cause a processor to perform the following:
implementing a decomposition algorithm that allows a solution of a comparatively larger linear programming problems that have a special block structure;
inserting a reinforcement learning agent within a framework of the decomposition algorithm; and
generating, in response to inserting the reinforcement learning agent, master problem decisions in place of an NP-hard (nondeterministic polynomial time-hard) mixed-integer master problem (MIMP).

16. The non-transitory computer readable medium according to claim 15, wherein the block structure occurs in applications that include stochastic programming as uncertainty is represented with scenarios.

17. The non-transitory computer readable medium according to claim 16, wherein the decomposition algorithm is benders decomposition (BD) algorithm that decomposes stochastic optimization problems on the basis of scenario independence into BD sub-problems.

18. The non-transitory computer readable medium according to claim 17, wherein the instructions, when executed, cause the processor to further perform the following:
implementing cuts from the BD sub-problems;
notifying, in response to implementing the cuts, selection of future master problem (MP)-agent solutions; and
combining the MP-agent solutions within a BD framework.

19. The non-transitory computer readable medium according to claim 16, wherein the reinforcement learning agent is configured to generate solutions to unseen problems after learning a loss of decisions in similar stochastic environments.

20. The non-transitory computer readable medium according to claim 19, wherein the instructions, when executed, cause the processor to further perform the following:
updating behaviors of the reinforcement learning agent based on learning the loss of decisions in similar stochastic environments, and
wherein for each iteration, a decision to use the reinforcement learning agent in place of the MIMP is drawn from a Bernoulli distribution with a control parameter, and when a value of “1” is returned from the Bernoulli distribution, the reinforcement learning agent is used to generate global decisions, and when a value of “0” is returned from the Bernoulli distribution, the MIMP is run and an optimality gap is confirmed.
